(19) United States
(12) Patent Application Publication
(10) Pub. No.: US 2011/0110763 A1
(43) Pub. Date: May 12, 2011

(54) Exhaust Ring and Method to Reduce Turbine Acoustic Signature

(75) Inventors: Joseph Andrew Tecza, Scio, NY (US); Stephen Samuel Rashid, Wellsville, NY (US)

(73) Assignee: DRESSER-RAND COMPANY, Olean, NY (US)

(21) Appl. No.: 12/614,159

(22) Filed: Nov. 6, 2009

(51) Int. Cl. F01D 25/04; B23P 11/00

(52) U.S. Cl. 415/119; 29/889.22

(57) ABSTRACT

Embodiments of the disclosure provide a turbine, an exhaust ring, and a method of reducing the acoustic signature of a turbomachine. In an embodiment, the turbine includes an exhaust ring disposed downstream from at least one stage of rotor blades and upstream from at least one fluid flow obstruction. An embodiment of the exhaust ring includes exhaust guide vanes having camber angles that are varied in a predetermined manner that cause a fluid flow to be diverted around a downstream obstruction in a manner that suppresses formation of a bow wave at the obstruction. An embodiment of the method includes adjusting a camber angle of a portion of a plurality of vanes, the camber angle directing a fluid flow around at least one fluid flow obstruction in a manner that suppresses formation of a bow wave at the fluid flow obstruction.

### BACKGROUND

The present invention relates to turbines, and more particularly to reducing turbine acoustic signature. In the exhaust end of a turbine, a nacelle is commonly braced with multiple pylons or struts. During turbine operation, bow waves may originate from these pylons or struts as fluid flow comes into contact with such pylons or struts. When these bow waves propagate upstream, they may back-pressure the rotor. Excitation of the rotor's blades by these bow waves generates noise.

Noise generation, which increases a turbine's acoustic signature, indicates an increase in aerodynamic losses caused by fluid energy that is not directed into the rotor assembly for power generation. Such aerodynamic losses contribute to turbine inefficiency.

Thus, there is a need for apparatus and methods for guiding non-uniform flow fields around downstream obstructions in order to reduce turbine acoustic signature and thereby increase turbine efficiency.

### SUMMARY

Embodiments of the disclosure may provide a turbine. The turbine may include a casing, at least one stage of rotor blades disposed in the casing, at least one stage of stator blades projecting inwardly from the casing and operatively associated with the rotor blades, and at least one fluid flow obstruction disposed downstream from the at least one stage of rotor blades. The turbine may further include an exhaust ring disposed downstream from the at least one stage of rotor blades and upstream from the at least one fluid flow obstruction, the exhaust ring including a plurality of non-uniform exhaust guide vanes that extend circumferentially around and project inwardly from the exhaust ring, the exhaust guide vanes configured to direct a fluid flow around the at least one fluid flow obstruction in a manner that suppresses formation of a bow wave at the fluid flow obstruction.

Embodiments of the disclosure may further provide an exhaust ring subject to a fluid flow from an upstream stage of turbine rotor blades. The exhaust ring may include a plurality of non-uniform exhaust guide vanes, the exhaust guide vanes having camber angles that are varied in a predetermined manner to cause a fluid flow traversing the exhaust guide vanes in a downstream direction to be diverted around at least one fluid flow obstruction disposed downstream of the exhaust ring in a manner that suppresses formation of a bow wave at the fluid flow obstruction.

Embodiments of the disclosure may further provide a method of reducing the acoustic signature of a turbomachine. The method may include identifying a fluid flow obstruction in an exhaust path of the turbomachine, providing a plurality of vanes upstream of the fluid flow obstruction, and adjusting a camber angle of a portion of the plurality of vanes, the camber angle directing a portion of the fluid flow around the at least one fluid flow obstruction in a manner that suppresses formation of a bow wave at the fluid flow obstruction.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a radially directed cross-sectional view through a portion of an exemplary turbine according to one or more aspects of the present disclosure.

FIG. 2 is a planiform view of a portion of an exemplary turbine according to one or more aspects of the present disclosure.

FIG. 3 is an axially directed schematic cross-sectional view through a portion of an exemplary turbine according to one or more aspects of the present disclosure.

FIG. 4 is a schematic cross-sectional view through an exemplary turbine according to one or more aspects of the present disclosure.

FIG. 5 is a flow chart of an exemplary method for reducing turbine acoustic signature according to one or more aspects of the present disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure. However, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope.

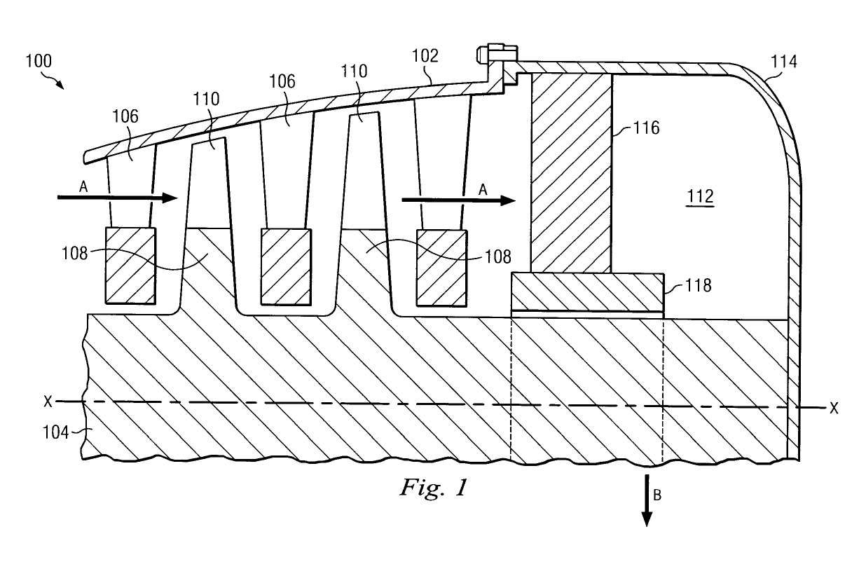

Referring to FIG. 1, there is shown a turbine 100 having an outer casing 102 and a rotor assembly 104. Embodiments of the present disclosure may be employed with various types of turbo machines, including impulse or reaction turbines, single stage, and multiple stage turbines. The turbine 100 of FIG. 1 illustrates a multi-stage steam turbine. In other embodiments, the turbine 100 may be any type of turbine or expander. Projecting inwardly from the casing 102, and circumferentially attached thereto in any suitable manner, are stator blades 106. The stator blades 106 are axially positioned at equally spaced intervals circumferentially about the rotor assembly 104. In other embodiments, the stator blades 106 are axially positioned at varying intervals.

The rotor assembly 104, having axis X-X, includes a plurality of roots 108, upon which a plurality of rotor blades 110, or airfoils, are mounted. The plurality of roots 108 and corresponding rotor blades 110 are axially spaced from, and adjacent to, the stator blades 106. The plurality of roots 108 and corresponding rotor blades 110 are positioned at equally spaced intervals. In other embodiments, the plurality of roots 108 and corresponding rotor blades 110 may be spaced at varying intervals. As illustrated, the stator blades 106 and the rotor blades 110 are positioned in an alternating interdigitated pattern, and the general direction of fluid flow through turbine 100 is shown by arrow A, i.e., from left to right. After passing through the stator blades 106 and rotor blades 110, the fluid enters an exhaust section 112 where it is exhausted in the direction of arrow B.

The exhaust section 112 includes an exhaust nacelle 114 that is mounted to the casing 102 in any appropriate manner. The nacelle 114 may be structurally supported against the resulting pressure and structural forces by at least one pylon 116, or strut. While only one pylon 116 is shown, in other embodiments, any number of pylons 116 may be used to provide a structural load bearing member for supporting the nacelle 114 in the exhaust region 112. A bearing housing 118 is located in the exhaust section 112, and is also supported by the at least one pylon 116. The at least one pylon 116 may be constructed with additional thickness in order to support the weight of the bearing housing 118 and the rotor assembly 104.

During exemplary operation of the turbine 100, a fluid is introduced at the left end of the turbine 100 and generates work as the fluid expands through the turbine stages in the direction of the arrow A. The fluid may include steam, air, products of combustion, or a process fluid, such as CO₂, or other fluid. The stator vanes 106 act as fixed nozzles configured to orient the fluid flow into high speed jets that are directed into general contact with the subsequent set of rotor blades 110. The fluid velocity increases and is directed into the rotor blades 110, which receive and convert the fluid flow into useful work, such as rotating the rotor assembly 104.

The fluid flowing out of the rotor blades 110 is generally relatively uniform in character. However, bow waves may originate from downstream stationary objects, such as the pylons 116, when the fluid flow comes into contact with such downstream stationary objects. When these bow waves propagate upstream, they cause circumferential pressure variation behind the rotor blades 110. Such pressure variation excites the rotor assembly 104, and may result in turbine 100 noise. Noise and rotor assembly 104 excitation are examples of inefficiencies that increase the acoustic signature of the turbine 100, and represent fluid energy that is not directed into the rotor assembly 104 to produce useful work. A reduction in the unsteady-state differential pressures across stationary downstream objects, including the pylons 116, may effectively attenuate resultant turbine 100 noise generation, and thereby increase turbine 100 efficiency.

According to at least one aspect of the present disclosure, a system of stator matching, or pylon matching, may be implemented to direct fluid flow substantially around stationary objects that are located downstream from any row of rotor blades 110 in order to suppress the non-uniform pressure field caused by the stationary objects. In an exemplary embodiment, as explained below, fluid flow may be substantially directed around a pylon 116. This reduces the strength of the pressure fields incident thereupon and thereby attenuates the resultant acoustic signature of the turbine 100.

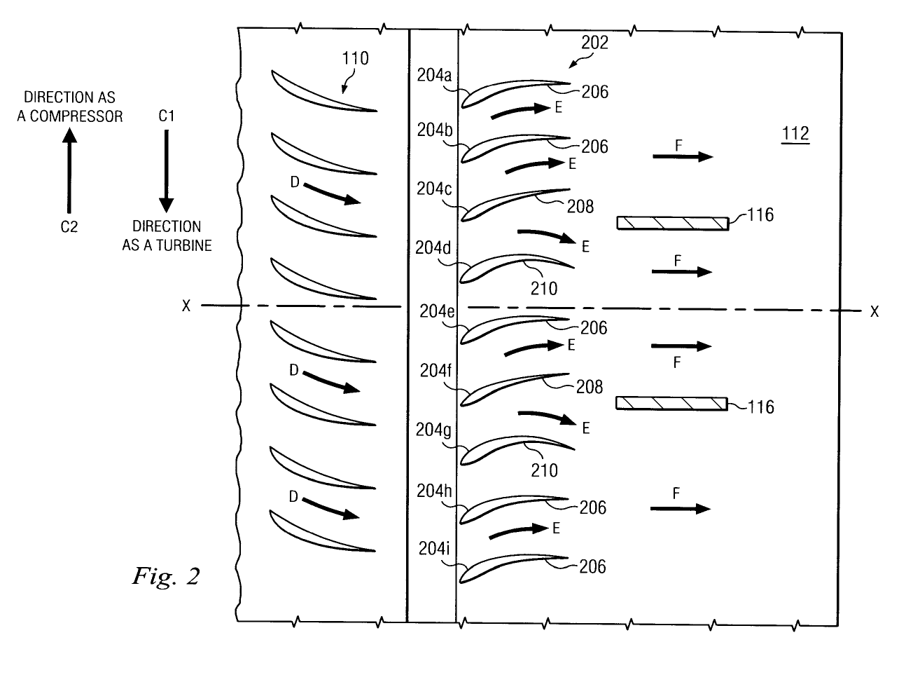

Referring to FIG. 2, with continued reference to FIG. 1, according to an exemplary embodiment of the present disclosure, a stationary exhaust ring 202 may be used to direct fluid flow substantially around downstream stationary obstructions, such as a pylon 116. The exhaust ring 202 extends circumferentially around the inner wall of the casing 102. In alternative embodiments, the exhaust ring 202 may extend circumferentially around the exhaust nacelle 114. Further, the exhaust ring 202 is removably coupled to the inner wall of the casing 102. However, in other embodiments, the exhaust ring 202 may be permanently coupled to the inner wall of the casing 102 or the nacelle 114. In the illustrated exemplary embodiment of FIG. 2, the exhaust ring 202 is disposed downstream from a last stage of rotor blades 110 and upstream from a pair of pylons 116 located in the exhaust section 112. It will be appreciated, however, that in alternative exemplary embodiments, the exhaust ring 202 may be disposed downstream from any stage of rotor blades 110, and upstream from at least one downstream stationary object.

As illustrated in FIG. 2, the exhaust ring 202 includes a plurality of non-uniform exhaust guide vanes 204a-i extending circumferentially around and projecting inwardly from the exhaust ring 202. The vanes 204 are disposed within the exhaust ring, and have non-uniform camber angles that are chosen to substantially direct the fluid flow around downstream stationary objects, such as the pylons 116, in a manner that suppresses the formation of bow waves at the downstream stationary objects.

The vanes 204 include concave and convex opposite sides, and are cambered at diverse angles so as to substantially direct the fluid flow around the individual pylons 116. Each of the vanes 204 have substantially the same leading edge geometry. However, the vanes 204 vary in geometry along the trailing edge.

As illustrated in FIG. 2, vanes 204a-b,e,h-i have a nominal camber angle with respect to axis X-X. Further, vanes 204c,f have a reduced camber angle with respect to axis X-X. Finally, vanes 204d,g have an increased camber angle with respect to axis X-X. As can be appreciated, varying the camber angles of the vanes 204 near the pylons 116 causes a substantial amount of fluid flow to be directed away from the leading edge of the pylons 116.

The embodiment shown in FIG. 2 is merely exemplary, and in other embodiments, the camber angles 206,208,210 may vary according to various predetermined schemes. For example, in another embodiment, certain vanes 204 may have no camber angle 206,208,210, and may instead form straight-through passages that are directed between downstream objects. In yet another embodiment, the exhaust ring 202 may include a plurality of vanes 204 having the following configuration: a nominal vane zero degree vane)(0°, a positive two degree vane)(+2°, a positive five degree vane)(+5°, a negative two degree vane)(−2°, and a negative five degree vane)(−5°. In such an embodiment, the vanes 204 may be arranged in packs depending on the number and size of the downstream obstruction(s). For example, an exhaust ring 202 may have fifty (50) vanes 204 that are arranged within the exhaust ring 202 according to the following configuration: ten 0° vanes, three +2° vanes, five +5° vanes, four −5° vanes, three −2° vanes, eleven 0° vanes, two 2° vanes, four +5° vanes, four −5° vanes, two −2° vanes, and two 0° vanes.

Still referring to FIG. 2, in exemplary operation, the last row of rotor blades 110 rotates in the direction of arrow C1 around a longitudinal or centerline axis X-X of the turbine 100. In another embodiment, if the turbine 100 is operating as a compressor, then the last row of rotor blades 110 rotates in the direction of arrow C2. The rotation of the blades 110 forces fluid in the direction of arrow D. As the fluid flow is directed into the exhaust ring 202, in the direction of arrow E, the vanes 204 receive fluid flow and redirect the fluid flow according to the respective camber of each vane 204. The cambered vanes 204 direct fluid flow away from the leading edge of the pylons 116, and instead direct the fluid flow around the pylons 116 in a generally axial direction, as shown by arrow F.

Directing the fluid flow around the pylons 116 suppresses the formation of bow waves at the pylons 116. If such bow waves were allowed to form, they could propagate upstream and cause back pressure on the rotor blades 110. Such back pressure may in turn cause excitation of the rotor blades 110. Thus, it may be appreciated that reducing the excitation of the rotor blades 110 by suppressing the formation of bow waves may reduce turbine 100 noise, and thereby increase the overall efficiency of the turbine 100.

In alternative exemplary embodiments of the present disclosure, the total number of non-uniform exhaust guide vanes 204 having non-uniform cambers disposed within the exhaust ring 202 may be reduced, and may instead be generally focused in an area closer to the downstream obstructions. For example, in an embodiment, the exhaust ring 202 includes a minimal number of vanes 204 disposed in a general area closer to a downstream obstruction, and the minimal number of vanes 204 are configured to direct the fluid flow around the downstream obstruction. Reducing the number of vanes 204 can advantageously decrease the turbine 100 weight, materials cost, and fabrication cost.

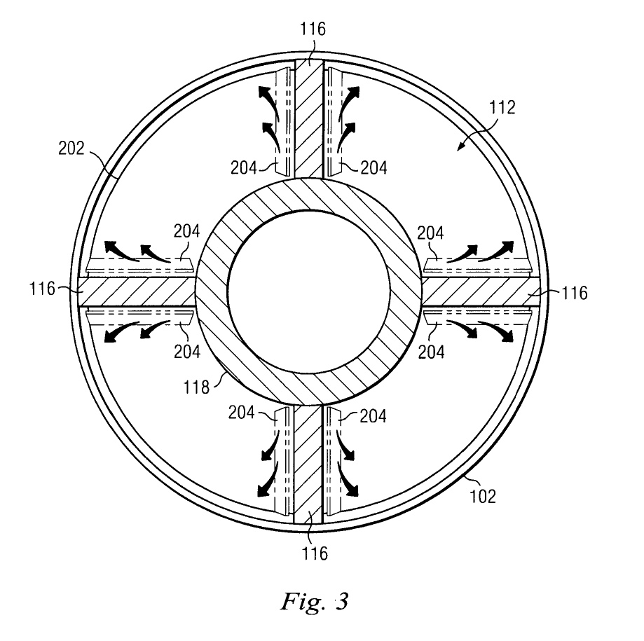

Referring now to FIG. 3, a perspective view of a portion of the turbine 100 according to one or more aspects of the present disclosure is shown. Four pylons 116, extend circumferentially inwardly from the casing 102 to the bearing housing 118, and provide support for the bearing housing 118. An exhaust ring 202, as illustrated in FIGS. 2 and 3, is disposed upstream from the four pylons 116, and is configured with vanes 204 (shown in phantom) having varying cambers that direct fluid flow away from the pylons 116. As illustrated in FIG. 3, the vanes 204 are circumferentially arranged around the exhaust ring 202, and project inwardly therefrom. Fluid flow is shown by the direction arrows surrounding the pylons 116. It should be understood that the fluid flow direction arrows are merely representative of the general direction of fluid flow away from the leading edge of the pylons 116, and that other embodiments of the present disclosure may direct fluid flow in different directions away from the leading edge of the pylons 116.

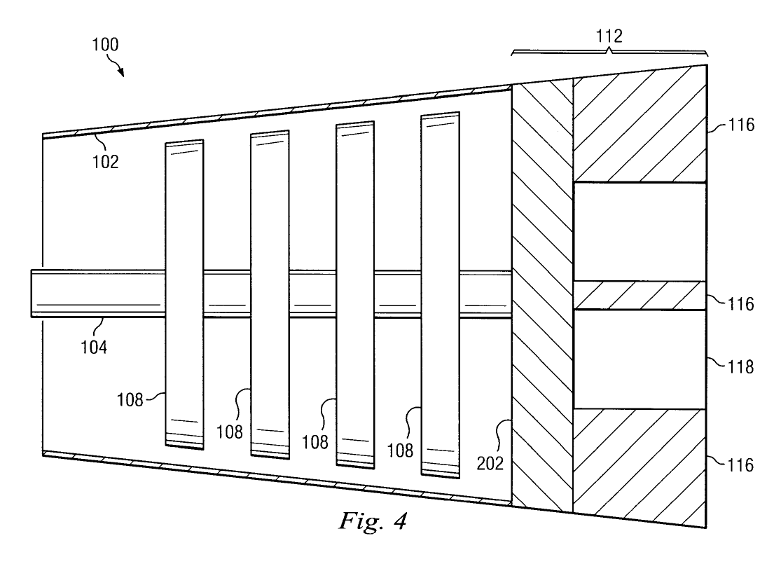

Referring now to FIG. 4, a top view of an exemplary turbine according to one or more aspects of the present disclosure is shown. FIG. 4 illustrates an exemplary position of the exhaust ring 202 within the turbine 100. In the illustrated exemplary embodiment of FIG. 3, the exhaust ring 202 is disposed after the last stage of rotor blades 110 and upstream from pylons 116 located in the exhaust section 112.

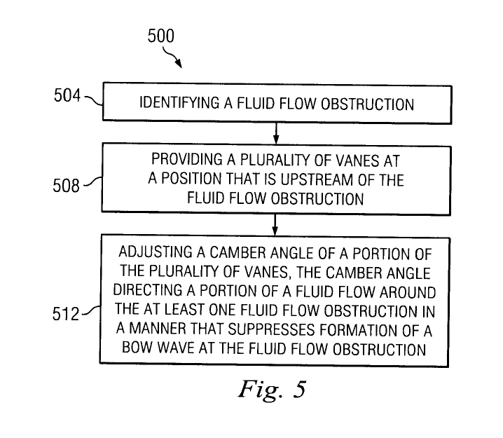

Referring now to FIG. 5, there is shown a flow chart of an exemplary method 500 of reducing a turbine's acoustic signature according to one or more aspects of the present disclosure. The method 500 provides for identifying a fluid flow obstruction, such as a pylon 116 illustrated in FIGS. 1-3, at a step 504. A block 508 includes providing a plurality of vanes, such as vanes 204 illustrated in FIGS. 2-3, at a position that is upstream of the fluid flow obstruction. Further, a block 512 includes adjusting a camber angle of a portion of the plurality of vanes, the camber angle directing a portion of a fluid flow around the at least one fluid flow obstruction in a manner that suppresses formation of a bow wave at the fluid flow obstruction.

Although the present disclosure has been described with respect to directing flow around pylons 116, embodiments of the present disclosure may be used to direct flow around other downstream stationary objects. In addition, there are potentially other geometries where embodiments of the present disclosure could be useful. For example, if the casing 102 is circumferentially non-uniform, embodiments of the present disclosure may be used to direct flow between opposing sides of an exhaust 112, induction, or extraction portion of the turbine 100. Additionally, to further minimize fluid flow obstruction, the pylons 116, or any downstream obstruction, may also be formed to be aerodynamically streamlined in a generally symmetrical tear drop shape that reduces pressure losses therefrom.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A turbine comprising:
a casing;
at least one stage of rotor blades disposed in the casing;
at least one stage of stator blades projecting inwardly from the casing and operatively associated with the rotor blades;
at least one fluid flow obstruction disposed downstream from the at least one stage of rotor blades; and
an exhaust ring disposed downstream from the at least one stage of rotor blades and upstream from the at least one fluid flow obstruction, the exhaust ring including a plurality of non-uniform exhaust guide vanes that extend circumferentially around and project inwardly from the exhaust ring, the exhaust guide vanes configured to direct a fluid flow around the at least one fluid flow obstruction in a manner that suppresses formation of a bow wave at the fluid flow obstruction.

2. The turbine of claim 1, wherein a first portion of the plurality of exhaust guide vanes is characterized by a first camber angle and a second portion of the plurality of exhaust guide vanes is characterized by a second camber angle different from the first camber angle.

3. The turbine of claim 1, wherein the at least one fluid flow obstruction comprises a pylon.

4. The turbine of claim 1, wherein each of the plurality of exhaust guide vanes comprise concave and convex opposite sides.

5. The turbine of claim 1, wherein a first portion of the plurality of exhaust guide vanes is characterized by at least one edge having no camber angle.

6. The turbine of claim 1, wherein the at least one stage of rotor blades comprises a single rotor blade stage.

7. The turbine of claim 1, wherein the at least one stage of rotor blades comprises a plurality of rotor blade stages.

8. The turbine of claim 1, the exhaust ring is disposed downstream from a last stage of the at least one stage of rotor blades.

9. An exhaust ring subject to a fluid flow from an upstream stage of turbine rotor blades, comprising:
a plurality of non-uniform exhaust guide vanes, the exhaust guide vanes having camber angles that are varied in a predetermined manner to cause a fluid flow traversing the exhaust guide vanes in a downstream direction to be diverted around at least one fluid flow obstruction disposed downstream of the exhaust ring in a manner that suppresses formation of a bow wave at the fluid flow obstruction.

10. The exhaust ring of claim 9, wherein a first portion of the plurality of exhaust guide vanes is characterized by a first camber angle and a second portion of the plurality of exhaust guide vanes is characterized by a second camber angle different from the first camber angle.

11. The exhaust ring of claim 9, wherein the plurality of exhaust guide vanes are circumferentially arranged around the exhaust ring.

12. The exhaust ring of claim 9, wherein each of the plurality of exhaust guide vanes project inwardly from the exhaust ring.

13. The exhaust ring of claim 9, wherein each of the plurality of exhaust guide vanes comprises concave and convex opposite sides.

14. A method of reducing the acoustic signature of a turbomachine, comprising:
identifying a fluid flow obstruction in an exhaust path of the turbomachine;
providing a plurality of vanes upstream of the fluid flow obstruction; and
adjusting a camber angle of a portion of the plurality of vanes, the camber angle directing a portion of a fluid flow around the at least one fluid flow obstruction in a manner that suppresses formation of a bow wave at the fluid flow obstruction.

15. The method of claim 14, wherein adjusting the camber angle includes adjusting a first camber angle of a first of the plurality of vanes to be different from a second camber angle of a second of the plurality of vanes.

16. The method of claim 14, further comprising:
coupling the plurality of vanes to an exhaust ring; and
forming each of the plurality of vanes to project inwardly from the exhaust ring.

17. The method of claim 16, further comprising arranging the plurality of vanes circumferentially around the exhaust ring.

18. The method of claim 14, further comprising forming the plurality of exhaust guide vanes to comprise concave and convex opposite sides.
